(19) United States
(12) Patent Application Publication
(10) Pub. No.: US 2017/0192838 A1
(43) Pub. Date: Jul. 6, 2017

(54) CPU SYSTEM INCLUDING DEBUG LOGIC FOR GATHERING DEBUG INFORMATION, COMPUTING SYSTEM INCLUDING THE CPU SYSTEM, AND DEBUGGING METHOD OF THE COMPUTING SYSTEM

(71) Applicant: SAMSUNG ELECTRONICS CO., LTD., SUWON-SI (KR)

(72) Inventors: KYOUNG-HEON JEONG, SUWON-SI (KR); JAE-YOUL KIM, YONGIN-SI (KR); SUNG-JAE LEE, SEOUL (KR); HO-SUNG KIM, HWASEONG-SI (KR)

(21) Appl. No.: 15/376,222

(22) Filed: Dec. 12, 2016

(30) Foreign Application Priority Data
Dec. 30, 2015 (KR) 10-2015-0189838

(51) Int. Cl. G06F 11/07

(52) U.S. Cl. CPC G06F 11/0721; G06F 11/0757; G06F 11/0772; G06F 11/079; G06F 11/0793

(57) ABSTRACT

A central processing unit (CPU) system includes a CPU configured to execute a program based on multiple pieces of register information, a CPU hang-up detector configured to detect a hang-up state of the CPU and generate a CPU hang-up occurrence signal, and a memory that stores debug logic configured to gather the multiple pieces of register information from the CPU in response to the CPU hang-up occurrence signal before a reset operation for the CPU is performed.

### CROSS-REFERENCE TO RELATED APPLICATION

This application claims the benefit of priority under 35 U.S.C. §119 to Korean Patent Application No. 10-2015-0189838, filed on Dec. 30, 2015, in the Korean Intellectual Property Office, the disclosure of which is incorporated herein in its entirety by reference.

### BACKGROUND

Field of the Disclosure

The present disclosure relates to a central processing unit (CPU) system, a computing system that includes the CPU system, and a debugging method of the computing system. More particularly, the present disclosure relates to a CPU system that includes debug logic for gathering debug information, a computing system that includes the CPU system, and a debugging method of the computing system.

Background Information

When a computing system operates, a hang-up state of the computing system may occur for various reasons. Sometimes, a hang-up state of a central processing unit (CPU) may also occur. The computing system may record log information about an operation of the computing system. When an error occurs in the computing system, a debugging operation that includes the reason for the occurrence of the error or an analysis of the error may be performed on the basis of the log information to debug the computing system. However, a debugging operation using the log information may not correctly determine information related to an instruction that is performed while a hang-up state of the computing system or CPU occurs. Thus, a lot of time is required for solving an error of the computing system or CPU.

### SUMMARY

The present disclosure describes a central processing unit (CPU) system that includes debug logic for gathering debug information necessary to quickly perform a debugging operation.

The present disclosure also describes a computing system that includes the CPU system.

Additionally, the present disclosure describes a debugging method of the computing system.

According to an aspect of the present disclosure, a central processing unit (CPU) system includes: a CPU configured to execute a program based on multiple pieces of register information; a CPU hang-up detector configured to detect a hang-up state of the CPU and generate a CPU hang-up occurrence signal; and a memory that stores debug logic configured to gather the multiple pieces of register information from the CPU in response to the CPU hang-up occurrence signal before a reset operation for the CPU is performed.

According to another aspect of the present disclosure, the multiple pieces of register information may include first program counter register information that includes a memory address. An instruction to be currently executed by the CPU is stored at the memory address.

According to yet another aspect of the present disclosure, the multiple pieces of register information may include link register information that includes a memory address. An instruction to be executed by the CPU in response to a branch return instruction is stored at the memory address.

According to still another aspect of the present disclosure, the CPU may include a stack area for storing stack information, wherein the multiple pieces of register information include program state register information that indicates an operation state of the CPU and stack pointer register information that includes a pointer address pointing to the stack information.

According to another aspect of the present disclosure, the debug logic may be configured to provide an operation completion signal to the CPU hang-up detector when an operation of gathering the multiple pieces of register information is completed, wherein the CPU hang-up detector is configured to control performing the reset operation for the CPU in response to the operation completion signal.

According to yet another aspect of the present disclosure, the CPU system may further include a cache unit in which cache data used when the CPU executes the program is stored, wherein CPU hang-up detector is configured to control performing the reset operation for the CPU and control performing an operation of preserving the cache data stored in the cache unit.

According to another aspect of the present disclosure, a computing system includes a central processing unit (CPU) system with a CPU configured to execute a program based on multiple pieces of register information and a debugger configured to debug the CPU system. A debugging method of the computing system includes detecting a hang-up state of the CPU system and generating a CPU hang-up occurrence signal; gathering the multiple pieces of register information from the CPU in response to the CPU hang-up occurrence signal before a reset operation for the CPU system is performed; and debugging, by the debugger, the CPU system based on the gathered pieces of register information.

According to another aspect of the present disclosure, the debugging method may further include: controlling the reset operation of the CPU system after completing the gathering of the multiple pieces of register information.

According to yet another aspect of the present disclosure, the CPU system may further include a cache unit configured to store cache data used when the CPU executes the program, wherein performing the reset operation includes controlling an operation of preserving the cache data stored in the cache unit.

The computing system may further include a memory device configured to store data used when the CPU executes the program, and the debugging method may further include flushing the preserved cache data to the memory device and updating data stored in the memory device.

### BRIEF DESCRIPTION OF THE DRAWINGS

Exemplary embodiments of the present disclosure will be more clearly understood from the following detailed description taken in conjunction with the accompanying drawings in which:

FIG. 1 is a block diagram illustrating a central processing unit (CPU) system according to an embodiment;

FIG. 2 is a block diagram specifically illustrating a CPU hang-up detector according to an embodiment;

FIG. 3 is a block diagram specifically illustrating a debug logic according to an embodiment;

FIG. 4A is a diagram for describing a debug information gathering operation according to an embodiment;

FIG. 4B is a diagram for describing a debug information gathering operation according to another embodiment;

FIG. 4C is a diagram for describing a debug information gathering operation according to another embodiment;

FIG. 5 is a diagram for describing a reset operation according to an embodiment;

FIG. 6 is a diagram for describing a flush operation for preserved cache data according to an embodiment;

FIG. 7 is a diagram illustrating a multi-CPU system that includes multiple CPUs according to an embodiment;

FIG. 8 is a diagram of a debugging method according to an embodiment;

FIG. 9 is a flowchart of a debugging method of a computing system according to an embodiment;

FIG. 10 is a flowchart of a debugging method of a computing system according to another embodiment;

FIG. 11 is a diagram illustrating a computer platform according to an embodiment; and

FIG. 12 is a diagram illustrating a computing system that includes a multi-CPU system according to an embodiment.

### DETAILED DESCRIPTION OF THE EMBODIMENTS

As used herein, the term “and/or” includes any and all combinations of one or more of the associated listed items. Expressions such as “at least one of” when preceding a list of elements, modify the entire list of elements and do not modify the individual elements of the list.

Hereinafter, example embodiments of the present disclosure will be described in detail with reference to the accompanying drawings. Embodiments of this disclosure are described so as to be thorough and complete, and to fully convey the concepts described herein to one of ordinary skill in the art. Since the present disclosure may have diverse modified embodiments, preferred embodiments are illustrated in the drawings and are described in the detailed description of the present disclosure. However, this does not limit the concepts described herein within specific embodiments and it should be understood that the present disclosure covers all the modifications, equivalents, and replacements within the idea and technical scope of the concepts described herein. Like reference numerals refer to like elements throughout. In the drawings, the dimensions and size of each structure are exaggerated, reduced, or schematically illustrated for convenience in description and clarity.

The terms used in this application, only certain embodiments have been used to describe, is not intended to limit the present embodiments. In the following description, the technical terms are used only for explain a specific exemplary embodiment while not limiting the present embodiments. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which concepts described herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

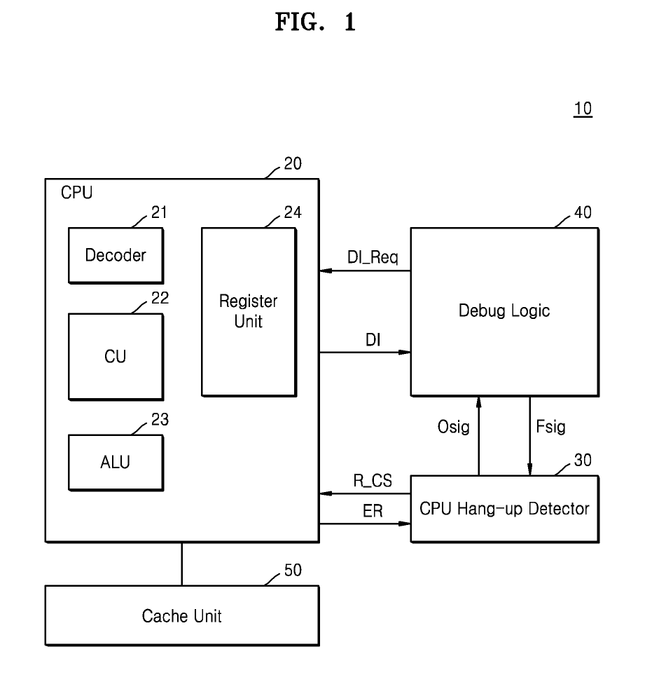

FIG. 1 is a block diagram illustrating a central processing unit (CPU) system according to an embodiment.

As shown in FIG. 1, the CPU system 10 may include a CPU 20, a CPU hang-up detector 30, a debug logic 40, and a cache unit 50. The CPU 20 may include a decoder 21, a control logic unit (CU) 22, an arithmetic logic unit (ALU) 23, and a register unit 24. The decoder 21 may decode an instruction received from the outside and provide a decoded instruction to the CU 22. The CU 22 may control an operation corresponding to the decoded instruction. In an embodiment, the CU 22 may control the ALU 23 to control a predetermined arithmetic operation. The register unit 24 may include multiple registers that store multiple pieces of register information. Each piece of information may be respectively stored in each of the registers. In an embodiment, the register unit 24 may include at least one of an instruction register, an address register, a data register, a program counter register, a link register, a stack pointer register, and a program state register. The CPU 20 may execute a program based on the pieces of register information stored in the register unit 24.

Data that is frequently used when the CPU 20 executes a program is stored in the cache unit 50. The cache unit 50 makes it possible to reduce the frequency of access to an external memory device having an input and output speed that is relatively low compared to that of the cache unit 50. The CPU 20 may use cache data, stored in the cache unit 50, when executing a program.

The CPU hang-up detector 30 may receive a program execution result signal ER from the CPU 20 and may detect a hang-up state of the CPU 20 based on the program execution result signal ER. The CPU 20 may periodically transmit the program execution result signal ER to the CPU hang-up detector 30 via a general purpose input output (GPIO) included in the CPU 20. The hang-up state of the CPU 20 may denote a state in which the CPU 20 stops program execution without any reason, or unexpectedly, or the CPU 20 does not execute a program any more when the CPU 20 enters a permanent loop during program execution. In addition, when the CPU 20 is in a hang-up state, the CPU system 10 may also be in the hang-up state. In an embodiment, the CPU hang-up detector 30 may detect that the CPU 20 is in a hang-up state when the program execution result signal ER is not received within a predetermined period of time or when the level of the program execution result signal ER is not changed within a predetermined period of time. However, this is only an embodiment and the CPU hang-up detector 30 may detect the hang-up state of the CPU 20 using a variety of methods. In an embodiment, the CPU hang-up detector 30 may determine whether the CPU 20 is in a hang-up state, by using a watch-dog operation method.

When the hang-up state of the CPU 20 is detected, the CPU hang-up detector 30 may provide a CPU hang-up occurrence signal Osig to the debug logic 40 to inform the debug logic 40 that a hang-up of the CPU 20 has occurred. In an embodiment, the CPU hang-up detector 30 may provide the CPU hang-up occurrence signal Osig to the debug logic 40 before controlling a reset operation for the CPU 20. Then the CPU hang-up detector 30 may not control the reset operation for the CPU 20 until the debug logic 40 receives a predetermined signal.

When the debug logic 40 receives the CPU hang-up occurrence signal Osig, the debug logic 40 may provide a debug information request signal DI_Req for requesting debug information to the CPU 20. The CPU 20 may provide debug information DI to the debug logic 40 in response to the debug information request signal DI_Req. In an embodiment, the debug information DI may include multiple pieces of register information stored in the register unit 24 of the CPU 20. In an embodiment, the debug logic 40 may request program counter register information that includes a memory address. An instruction which the CPU 20 has to presently execute is stored at the memory address. The debug logic 40 may also gather register information including the program counter register information. In another embodiment, the debug logic 40 may request link register information that includes a memory address. An instruction, which the CPU 20 has to execute in response to a branch return instruction, is stored in memory at the memory address. The debug logic 40 may also gather register information that includes the link register information. In another embodiment, the debug logic 40 may request state register information that indicates an operation state of the CPU 20 and stack pointer register information that includes a pointer address pointing to stack information. The debug logic may also gather register information including the state register information and the stack pointer register information. However, this is only an embodiment and the debug logic 40 may request various pieces of register information stored in the CPU 20 and gather the various pieces of register information.

In an embodiment, when the debug logic 40 provides the debug information request signal DI_Req to the CPU 20, the CU 22 may convert a multiple pieces of register information stored in the register unit 24 into a context in response to the debug information request signal DI_Req and provide the context to the debug logic 40. The context may include all pieces of register information used in order for the CPU 20 to execute a program when the CPU receives the debug information request signal DI_Req. Furthermore, the control logic 22 may select at least one of the multiple pieces of register information and convert the selected register information into a context. Debug information DI that is received by the debug logic 40 from the CPU 20 may include the context. The debug logic 40 may store the debug information DI gathered from the CPU 20. Furthermore, the debug logic 40 may include an internal debugger and perform a debugging operation for the CPU 20 based on gathered debug information DI.

The debug logic 40 may provide a gathering operation completion signal Fsig to the CPU hang-up detector 30 when an operation of gathering the debug information DI is completed. The CPU hang-up detector 30 may provide a reset control signal R_CS to the CPU 20 in response to the gathering operation completion signal Fsig. The CPU 20 may be reset in response to the reset control signal R_CS. In addition, in an embodiment, the CPU hang-up detector 30 may selectively target blocks, on which a reset operation is to be performed, before controlling the reset operation. For example, the CPU hang-up detector 30 may selectively target blocks other than the cache unit 50, and not target the cache unit 50 as a target block on which a reset operation is to be performed. Accordingly, the CPU hang-up detector 30 may control performing a reset operation on blocks other than the cache unit 50. Such an operation of the CPU hang-up detector 30 may be referred to as a selective reset operation. In other words, the CPU hang-up detector 30 may perform a reset operation for target blocks that include the decoder 21, the CU 22, the ALU 23, and the register unit 24. Accordingly, data and register information, stored in each target block, may be deleted. In this case, cache data stored in the cache unit 50 may be preserved even after a reset operation for the CPU 20 has been completed. Then, the CPU 20 may perform a flush operation of flushing the cache data stored in the cache unit 50 to an external memory device, thereby updating data of the external memory device.

According to an embodiment, the debug logic 40 may provide gathered debug information DI to a debugger via a joint test action group (JTAG) interface and the like. The debugger may perform a debugging operation for the CPU system 10 or the CPU 20, based on at least one of the debug information DI and updated data stored in the external memory device.

The debug logic 40 may gather register information at a point in time when a hang-up has occurred in the CPU 20 before a reset operation is performed. The debug logic 40 may utilize the gathered register information as debugging information during a subsequent debugging operation. Thus, a time that is required for the debugging operation may be reduced.

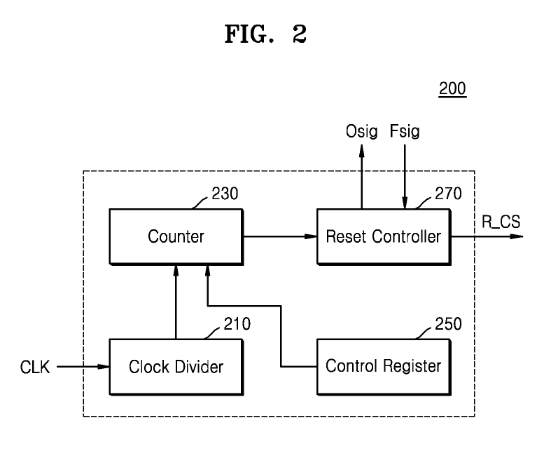

FIG. 2 is a block diagram specifically illustrating a CPU hang-up detector 200 according to an embodiment.

As shown in FIG. 2, the CPU hang-up detector 200 may include a clock divider 210, a counter 230, a control register 250, and a reset controller 270. The clock divider 210 may divide a clock signal CLK. A clock signal divided from the clock divider 210 may be provided to the counter 230. The counter 230 may count a divided clock signal. The counter 230 may initialize a counted value whenever an initialization instruction is executed from the CPU 20 of FIG. 1. When the CPU 20 stops program execution without any reason, or unexpectedly, or the CPU 20 falls in a permanent loop during program execution, the counter 230 is not initialized and thus may provide an excess signal to the reset controller 270. The control register 250 may include various setting bits for controlling an operation of the CPU hang-up detector 200. In an embodiment, the control register 250 may include a reset setting bit that may be set by the CPU 20. The reset controller 270 may control a reset operation based on a valid reset setting bit of the control register 250 and an excess signal received from the counter 230. In an embodiment, the reset controller 270 may generate a CPU hang-up occurrence signal (i.e., the CPU hang-up occurrence signal Osig of FIG. 1) when a hang-up state of the CPU 20 is detected. After the reset controller 270 receives a predetermined signal from the outside, the reset controller 270 may generate a reset control signal R_CS and control a reset operation of the CPU 20. In an embodiment, the predetermined signal may correspond to the gathering operation completion signal Fsig that is provided to the reset controller 170 after the debug logic 40 of FIG. 1 completes debug information gathering.

When a hang-up state of a CPU or CPU system is detected, the CPU hang-up detector 200 according to the current embodiment may secure a time. The secured time may be a time required until a debug logic completes gathering register information of the CPU. The secured time may be secured by limiting a reset operation for the CPU or CPU system until a predetermined signal is received from the outside.

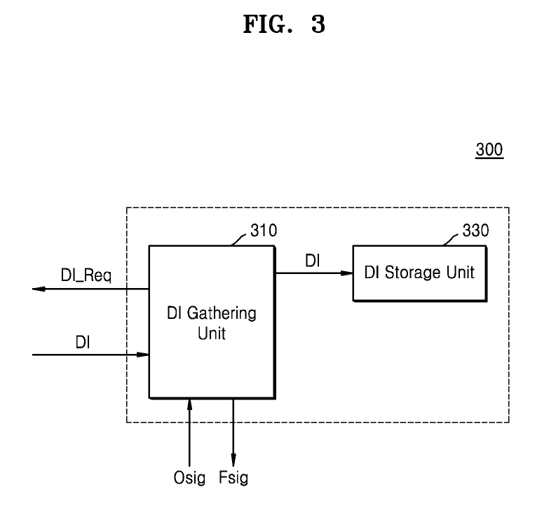

FIG. 3 is a block diagram specifically illustrating a debug logic 300 according to an embodiment.

As shown in FIG. 3, the debug logic 300 may include a debug information (DI) gathering unit 310 and a DI storage unit 330. The DI gathering unit 310 may receive the CPU hang-up occurrence signal Osig from the CPU hang-up detector 30 of FIG. 1 and perform a debug information gathering operation in response to the received CPU hang-up occurrence signal Osig. The DI gathering unit 310 may provide the debug information request signal DI_Req to the CPU 20 of FIG. 1 to gather debug information DI. The CPU 20 may provide the debug information DI to the DI gathering unit 310 in response to the debug information request signal DI_Req. The debug information DI may include multiple pieces of register information stored in the register unit 24 of the CPU 20. Gathered debug information DI may be stored in the DI storage unit 330. When a debugger performs a debug operation for the CPU 20 or the CPU system 10, the debug logic 300 may provide stored debug information DI to the debugger.

When a hang-up state of a CPU or CPU system occurs, the debug logic 300 according to the current embodiment may gather register information stored in the CPU as debug information. The debug logic 300 may use the gathered register information in a subsequent debugging operation, and thus may quickly correct errors.

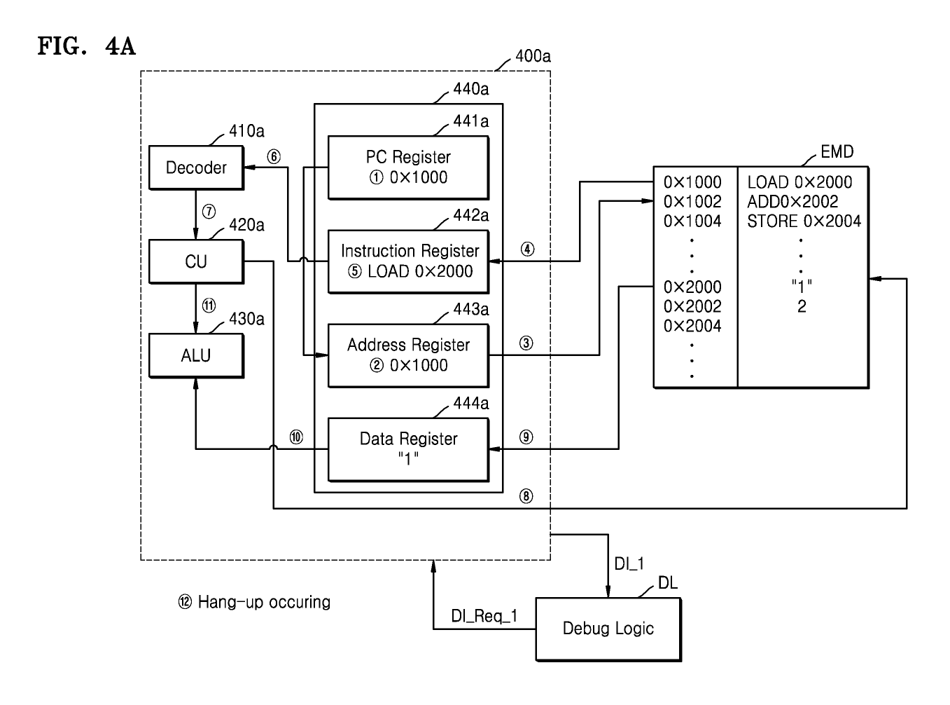

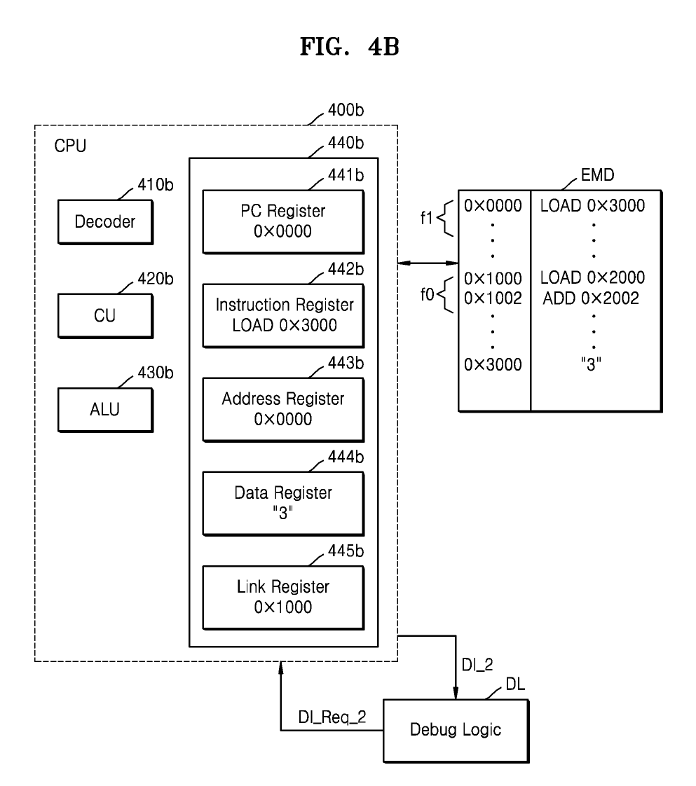

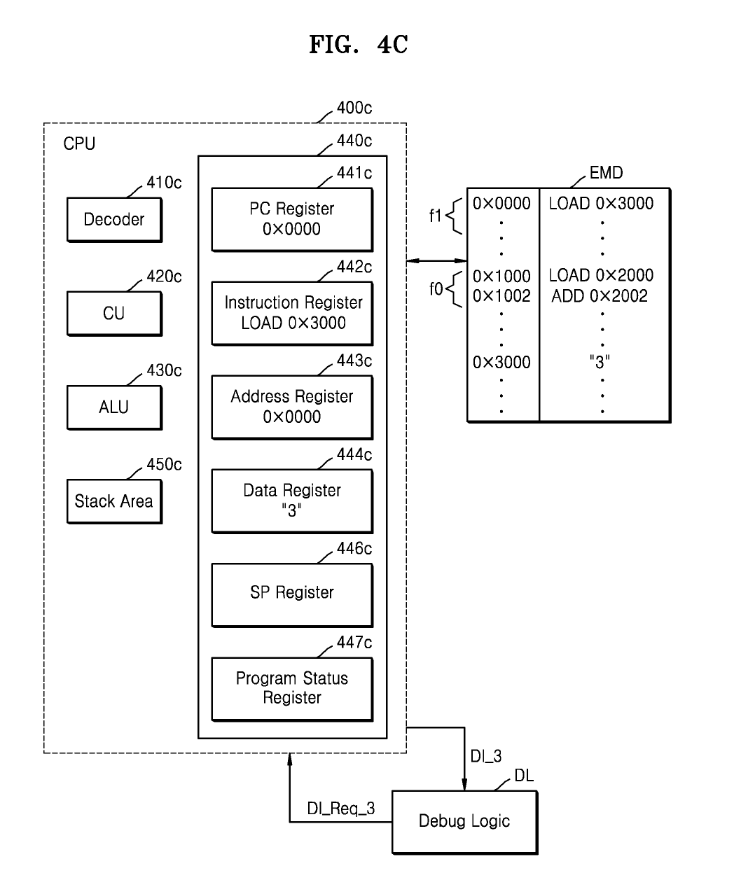

FIG. 4A is a diagram for describing a debug information gathering operation according to an embodiment.

As shown in FIG. 4A, a CPU 400a may include a decoder 410a, a CU 420a, an ALU 430a, and a register unit 440a. To describe the debug information gathering operation, an external memory device EMD and a debug logic DL are illustrated in FIG. 4A. The register unit 440a may include a program counter register 441a, an instruction register 442a, an address register 443a, and a data register 444a.

The CPU 400a may use program counter register information, stored in the program counter register 441a, to execute a program. Register information that includes a memory address may be stored in the program counter register 441a (operation \textcircled{1}). An instruction to be executed by the CPU 400a is stored at the memory address. In an embodiment, the memory address may be a memory address for the external memory device EMD connected to the CPU 400a via a bus. For example, the program counter register 451a may store program counter register information, for example, “0x1000”. The “0x1000” may be stored in the address register 443a (operation \textcircled{2}), and the CPU 400a may access the external memory device EMD by using the “0x1000” (operation \textcircled{3}). In an embodiment, the external memory device EMD may include instruction information for the CU 420a and data information related to the instruction information. For example, data, which includes information about a “LOAD” instruction and memory address information with data related to the “LOAD” instruction, that is, memory address information with data such as “0x2000”, may be stored in a memory address “0x1000” of the external memory device EMD. The CPU 400a may read data “LOAD 0x2000” stored in the address “0x1000” of the external memory device EMD and store the read data in the instruction register 442a (operations \textcircled{4} and \textcircled{5}). The decoder 410a may decode the data “LOAD 0x2000” read from the external memory device EMD (operation \textcircled{6}). The CU 420a may receive a decoding result (operation \textcircled{7}) and may read data “1”, stored in the address “0x2000” of the external memory device EMD, based on the decoding result and then store the read data in the data register 444a (operations \textcircled{8} and \textcircled{9}). Also, the CU 420a may control an arithmetic operation of the ALU 430a using the data “1”, based on the decoding result (operations \textcircled{10} and \textcircled{11}).

When a hang-up state occurs in the CPU 400a during the above-described operation (operation \textcircled{12}), the debug logic DL may provide a debug information request signal DI_Req_1 to the CPU 400a. The CPU 400a may provide debug information to the debug logic DL in response to the debug information request signal DI_Req_1. In an embodiment, the debug information DL_1 may include program counter register information stored in the program counter register 441a.

In this manner, the CPU 400a may execute an instruction by using the program counter register information. Accordingly, by referring to the program counter register information when the CPU 400a is in a hang-up state, information about an instruction executed before the CPU 400a is in the hang-up state may be extracted and a debugging operation may be quickly performed by using the extracted information.

Furthermore, when the CPU 400a executes a program by using a pipe-line method, offset information corresponding to the program counter register information may be generated. Then, the CPU 400a may generate register information using the offset information and the program counter register information. The register information may include a memory address in which an instruction that is presently executed by the CPU 400a is stored, by. In other words, when the CPU 400a executes a program by using the pipe-line method, an instruction that is executed by the CPU 400a may be different from the program counter register information. Accordingly, the CPU 400a may generate offset information for correcting the difference, generate register information that includes a memory address using the offset information, and provide the generated register information to the debug logic DL. An instruction that is presently executed by the CPU 400a is stored at the memory address. However, this is only an embodiment, and the debug logic DL may generate the offset information and the register information or an additional logic may generate the offset information and the register information. However, CPUs described herein are not limited thereto.

FIG. 4B is a diagram for describing a debug information gathering operation according to another embodiment.

As shown in FIG. 4B, a register unit 440b may further include a link register 445b, compared to the register unit 440a illustrated in FIG. 4A. The register unit 440b may be the same as the register 440a of FIG. 4A except that the register unit 440b further includes the link register 445b. A CPU 400b may call a sub-function f1 in response to a branch instruction while a program is executed via a main function f0. Then, the CPU 400b may return to the main function f0 in response to a branch return instruction. In this case, link register information, which includes a memory address may be stored in the link register 445b. An instruction which the CPU 400b has to execute in response to the branch return instruction is stored at the memory address.

For example, in order to execute a program via the sub-function f1, program counter register information that includes a memory address corresponding to “0x0000” may be stored in a program counter register 441b. Similar to the method described above, the memory address corresponding to “0x0000” may be stored in an address register 443b, and “LOAD 0x3000” read from an external memory device EMD may be stored in an instruction register 442b. A data register 444b may store “3” read from the external memory device EMD. Link register information that includes a memory address corresponding to “0x1000” may be stored in the link register 445b in order to execute a program via the main function f0 again in response to a subsequent branch return instruction. In other words, link register information, which includes a memory address may be stored in the link register 445b. An instruction which the CPU 400b has to execute in response to a branch return instruction is stored at the memory address.

When a hang-up state occurs in the CPU 400b, a debug logic DL may provide a debug information request signal DI_Req_2 to the CPU 400b. The CPU 400b may provide debug information DI_2 to the debug logic DL in response to the debug information request signal DI_Req_2. In an embodiment, the debug information DL_2 may include link register information stored in the link register 445b.

In this manner, the CPU 400b may execute an instruction on the basis of the link register information. Accordingly, by referring to the link register information when the CPU 400a is in a hang-up state, the CPU 400b may return to a state before the hang-up state and thus information about an instruction scheduled to be executed may be extracted, and a debugging operation may be quickly performed on the basis of the extracted information.

FIG. 4C is a diagram for describing a debug information gathering operation according to another embodiment.

As shown in FIG. 4C, a CPU 400c may further include a stack area 450c, and a register unit 440c may further include a stack pointer register 446c and a program status register 447c, compared to the register unit 440a illustrated in FIG. 4A. Elements other than the stack pointer register 446c and the program status register 447c may correspond to elements of the register 440a of FIG. 4A. The CPU 400c may use the stack area 450c to execute a program. In other words, the CPU 400c may input or output stack information to or from the stack area 450c while executing a program. In this case, stack pointer register information for accessing the stack information may be stored in the stack pointer register 446c. In addition, program status information, which includes information about an operation mode during the program execution of the CPU 400c, may be stored in the program status register 447c.

When a hang-up state occurs in the CPU 400c, a debug logic DL may provide a debug information request signal DI_Req_3 to the CPU 400c. The CPU 400c may provide debug information DI_3 to the debug logic DL in response to the debug information request signal DI_Req_3. In an embodiment, the debug information DL_3 may include at least one of program status register information and stack pointer register information. Furthermore, the debug information DL_3 may further include stack information stored in the stack area 450c.

In this manner, the CPU 400c may execute an instruction by using the program status register information and the stack pointer register information. Accordingly, by referring to the stack pointer register information when the CPU 400c is in a hang-up state, stack information of the stack area 450c, used before the CPU 400c is in a hang-up state, may be extracted. In addition, since the stack area 450c that is used is changed according to an operating state of the CPU 400c, the stack information may be extracted by referring the program status register information in addition to the stack pointer register information, and a debugging operation may be quickly performed by using the extracted information.

Descriptions provided with reference to FIGS. 4A to 4C correspond to only embodiments, and the debug information DI_1, DI_2, and DI_3 that is provided to the debug logic DL may include at least one of program counter register information, instruction register information, address register information, data register information, link register information, stack pointer register information, and program status register information. Each of the CPUs 400a, 400b, and 400c may convert register information stored in each register into context in response to the debug information request signals DI_Req_1, DI_Req_2, and DI_Req_3, respectively, and provide the respective context to the debug logic DL as the debug information DI_1, DI_2, and DI_3, respectively.

Furthermore, the debug logic DL may select at least one from the program counter register information, the instruction register information, the address register information, the data register information, the link register information, the stack pointer register information, and the program status register information and request the CPUs 400a, 400b, and 400c to send the selected register information.

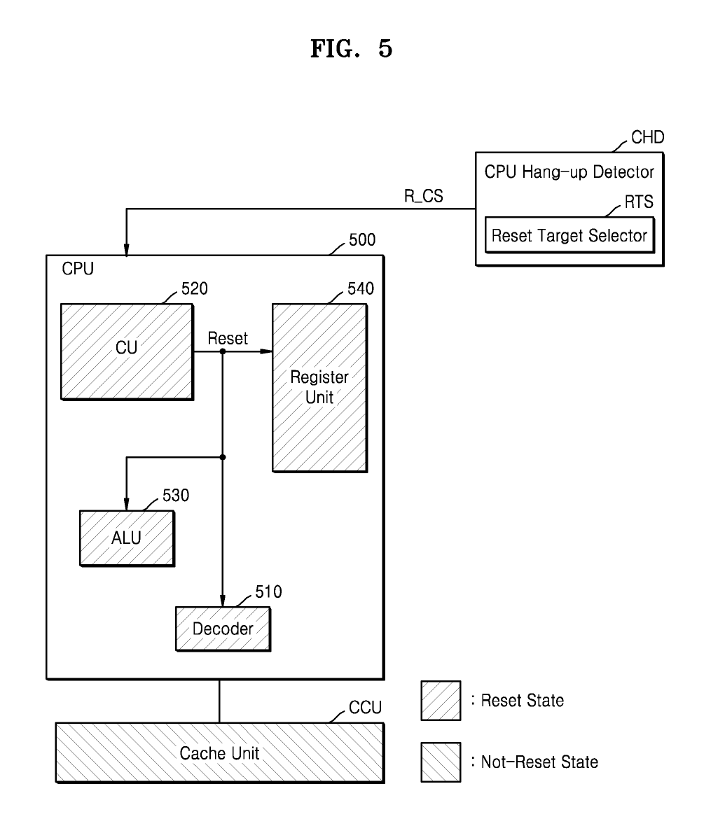

FIG. 5 is a diagram for describing a reset operation according to an embodiment.

As shown in FIG. 5, a CPU 500 may include a decoder 510, a CU 520, an ALU 530, and a register unit 540. A CPU hang-up detector CHD may provide a rest control signal R_CS to the CPU 500 when a hang-up state of the CPU 500 is detected and the gathering of register information of the CPU 500 is completed. In an embodiment, the CPU hang-up detector CHD may further include a rest target selector RTS that may select a target block on which a reset operation is performed. For example, the reset target selector RTS may not select a cache unit CCU as a target block on which a reset operation is performed, and thus, the CPU hang-up detector CHD may control performing a reset operation on blocks other than the cache unit CCU. In other words, the CPU hang-up detector CHD may perform a reset operation on target blocks that includes the decoder 510, the CU 520, the ALU 530, and the register unit 540. Thus, data and register information, stored in each target block, may be deleted. However, this is only an embodiment, and various blocks that are not illustrated for convenience of description may also be reset. In this case, cache data stored in the cache unit 50 may be preserved even after a reset operation for the CPU 20 has been completed.

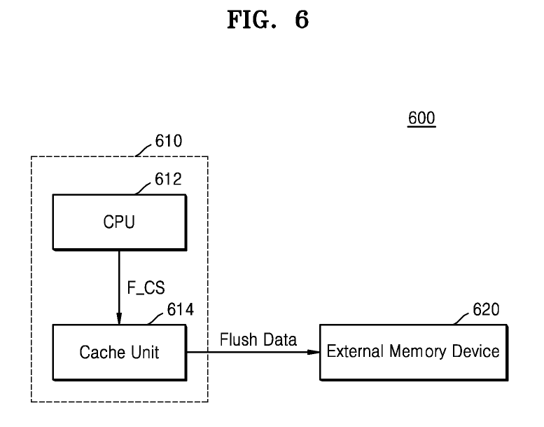

FIG. 6 is a diagram for describing a flush operation for preserved cache data according to an embodiment.

As shown in FIG. 6, a computing system 600 may include a CPU system 610 and an external memory device 620. The CPU system 610 may include a CPU 612 and a cache unit 614. When the computing system 600 is rebooted after a reset operation is performed, the CPU 612 may provide a flush control signal F_CS to the cache unit 614. The cache unit 614 may flush flush data, which includes cache data preserved with a method described with reference to FIG. 5, to the external memory device 620 in response to the flush control signal F_CS. Through this operation, the external memory device 620 may update previously stored data by using the flush data. Updated data stored in the external memory device 620 may be used when a debugging operation is performed.

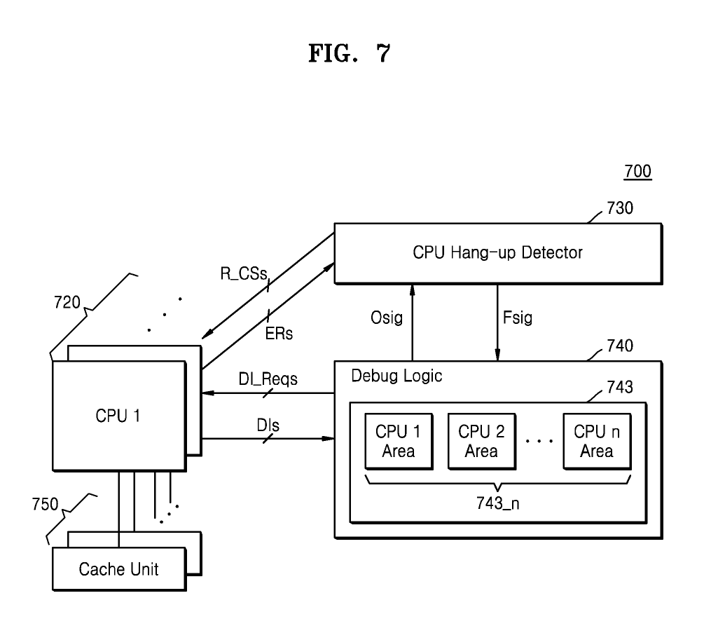

FIG. 7 is a diagram illustrating a multi-CPU system 700 that includes multiple CPUs according to an embodiment.

As shown in FIG. 7, the multi-CPU system 700 may include a multiple CPUs 720, a CPU hang-up detector 730, a debug logic 740, and multiple cache units 750. The CPUs 720 may provide execution result signals ERs for program execution thereof to the CPU hang-up detector 730. The CPU hang-up detector 730 may detect a hang-up state of at least one of the CPUs 720, based on the execution result signals ERs.

When a hang-up state of at least one of the CPUs 720 is detected, the CPU hang-up detector 730 may provide a CPU hang-up occurrence signal Osig to the debug logic 740. The debug logic 740 may provide debug information request signals DI_Reqs to the multiple CPUs 720 in response to the CPU hang-up occurrence signal Osig. The CPUs 720 may provide debug information DIs to the debug logic 740 in response to the debug information request signals DI_Reqs. In an embodiment, the debug information DIs) may include multiple pieces of register information stored in each of the CPUs 720. The debug logic 740 may further include a debug information storage unit 743. The debug information storage unit 743 may be divided into multiple storage areas 743_n corresponding to the CPUs 720, and thus, the debug information storage unit 743 may store the pieces of register information according to the CPUs 720 corresponding thereto.

In another embodiment, the debug logic 740 may select some of the multiple CPUs 720 and provide the debug information request signals DI_Reqs to the selected CPUs. The debug logic 740 may select CPUs in which a hang-up has occurred from among the CPUs 720 or select only CPUs in which a hang-up state occurs more times than a threshold number, and may provide the debug information request signals DI_Reqs to the selected CPUs. Through this operation, the debug logic 740 may reduce the amount of debug information DIs, which is stored in the debug information storage unit 743, by gathering the debug information DIs only from the selected CPUs.

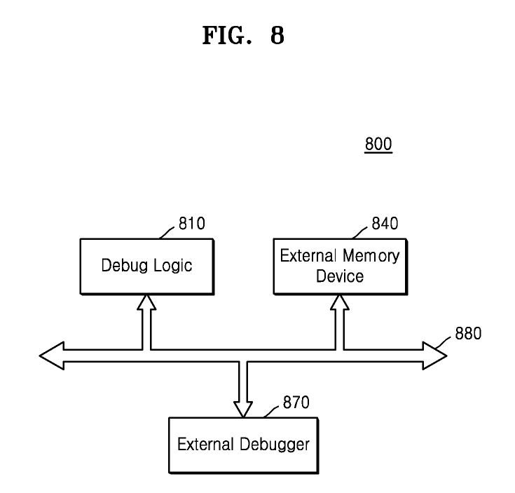

FIG. 8 is a diagram for describing a debugging method according to an embodiment.

As shown in FIG. 8, a computing system 800 may include a debug logic 810, an external memory device 840, an external debugger 870, and a data bus 880. As described with reference to FIGS. 1 to 7, the debug logic 810 may gather multiple pieces of register information stored in a CPU and store the gathered register information, and the external memory device 840 may store data updated by using cache data of a cache unit that has not been reset. When the external debugger 870 performs debugging for the CPU or a CPU system, the register information gathered by the debug logic 810 may be provided to the external debugger 870 via the data bus 880. In addition, the updated data of the external memory device 840 may be provided to the external debugger 870 via the data bus 880. The external debugger 870 may perform debugging based on at least one of the register information and the updated data. However, this is only an embodiment, and the debug logic 810, the external memory device 840, and the external debugger 870 may transmit or receive information that includes the register information and the updated data to or from each other through communication.

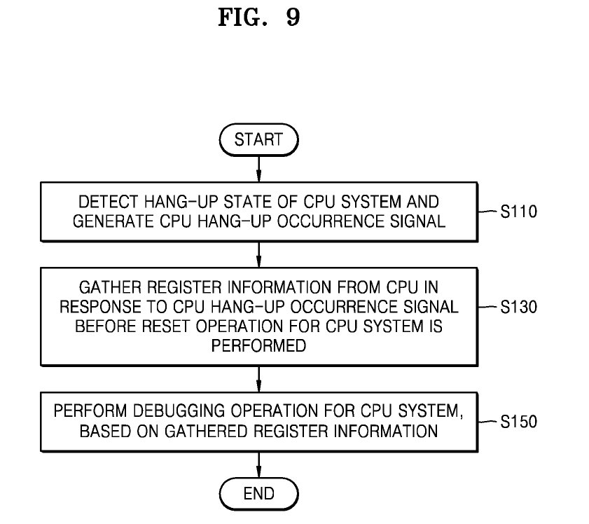

FIG. 9 is a flowchart for describing a debugging method of a computing system according to an embodiment.

As shown in FIG. 9, a CPU hang-up detector detects a hang-up state of a CPU system and generates a CPU hang-up occurrence signal (operation S110). Before a reset operation for the CPU system is performed, a debug logic gathers register information from a CPU in response to the CPU hang-up occurrence signal (operation S130). A debugger performs a debugging operation for the CPU system, based on the gathered register information (operation S150).

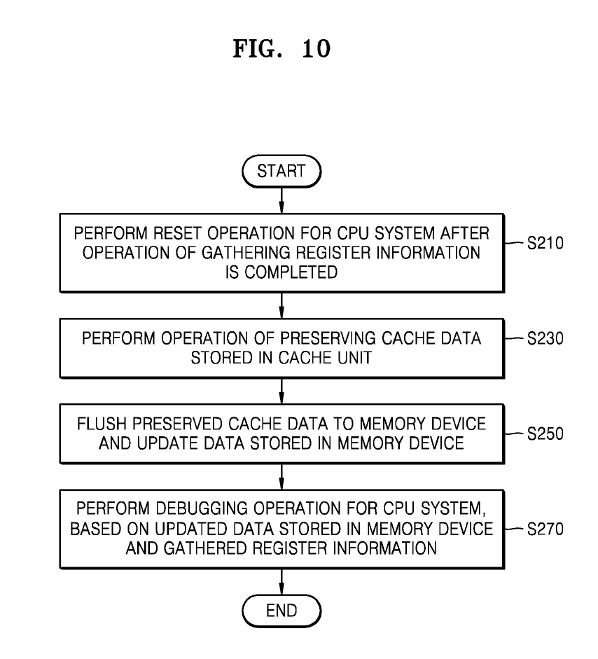

FIG. 10 is a flowchart for describing a debugging method of a computing system according to another embodiment.

As shown in FIG. 10, a CPU hang-up detector controls a reset operation for a CPU system after an operation of gathering register information, which is performed by a debug logic, is completed (operation S210). The CPU hang-up detector controls an operation of preserving cache data stored in a cache unit (operation S230). After the CPU system is rebooted, the CPU system flushes cache data stored in the cache unit to a memory device and updates data previously stored in the memory device (operation S250). A debugger performs a debugging operation for the CPU system, based on updated data stored in the memory device and gathered register information (operation S270).

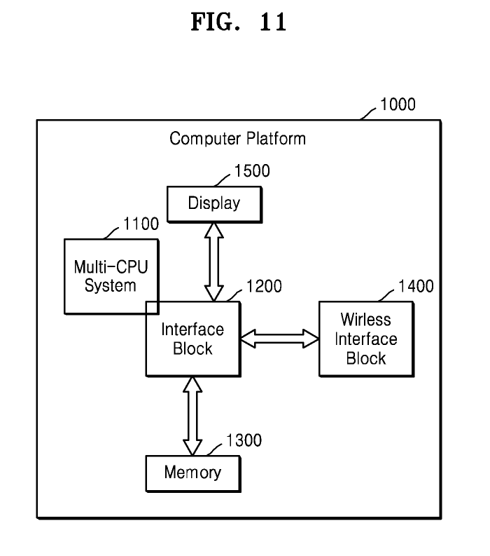

FIG. 11 is a diagram illustrating a computer platform 1000 according to an embodiment.

As shown in FIG. 11, the computer platform 1000 may be used in an electronic device such as a computing system. The electronic device may be implemented as a personal computer (PC), a digital television (TV), or a portable device. The portable device may be implemented as a laptop computer, a mobile phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, or an e-book.

The computer platform 1000 includes a multi-CPU system 1100, an interface block 1200, and a memory device 1300. According to an embodiment, the computer platform 1000 may further include at least one of a wireless interface block 1400 and a display 1500.

The multi-CPU system 1000 may communicate with the memory device 1300, the wireless interface block 1400, or the display 1500 via the interface block 1200. As described above with reference to FIGS. 1 to 10, when a hang-up state of a CPU of the multi-CPU system 1000 is detected, a debug logic in the multi-CPU system 1000 may gather register information, stored in multiple CPUs, as debug information before a reset operation for the multi-CPU system 1000 is performed. Gathered debug information may be provided to a debugger via the interface block 1200 or the wireless interface block 1400, and the debugger may quickly perform debugging based on the debug information. The interface block 1200 includes one or more circuit blocks that may perform various interface control functions. The interface control functions include memory access control, graphic control, input and output interface control, or wireless network access control. The circuit blocks may be implemented as independent chips, may be implemented as parts of the multi-CPU system 1000, or may be implemented inside the multi-CPU system 1000. The memory device 1300 may send or receive data to or from the multi-CPU system 1000 via the interface block 1200.

The wireless interface block 1400 may connect the computer platform 1000 to a wireless network, for example, a mobile communication network or a wireless local area network (LAN), via an antenna.

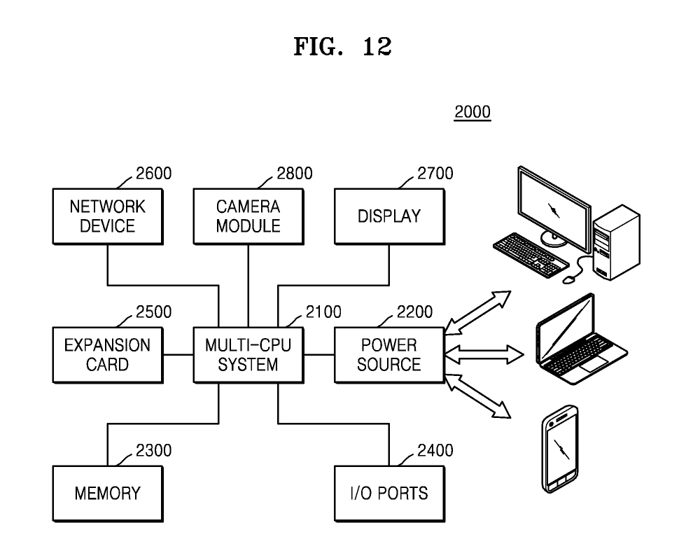

FIG. 12 is a diagram illustrating a computing system 2000 that includes a multi-CPU system according to an embodiment.

As shown in FIG. 12, the computing system 2000 may be implemented as a PC, a data server, a laptop computer, or a portable device. The computing system 2000 may include a multi-CPU system 2100, a power source 2200, a memory device 2300, input/output (I/O) ports 2400, an expansion card 2500, a network device 2600, and a display 2700. According to an embodiment, the computing system 2000 may further include a camera module 2800. The multi-CPU system 2100 may control an operation of at least one of the elements 2200 to 2800. As described above with reference to FIGS. 1 to 10, when a hang-up state of a CPU of the multi-CPU system 2100 is detected, a debug logic in the multi-CPU system 2100 may gather register information, stored in multiple CPUs, as debug information before a reset operation for the multi-CPU system 2100 is performed. The power source 2400 may supply an operating voltage to at least one of the elements 2300 to 2800. The memory device 2300 may be implemented as a volatile memory device or a non-volatile memory device. According to an embodiment, a memory controller, which may control a data access operation for the memory device 2300, for example, a read operation, a write operation (or program operation), or an erase operation, may be integrated (or embedded) in the multi-CPU system 2100. According to another embodiment, the memory controller may be separately implemented between the multi-CPU system 2100 and the memory device 2300. The I/O ports 2400 are ports that may transmit data to the computing system 2000 or transmit data output from the computing system 2000 to an external device.

For example, the I/O ports 2400 may include at least one of a port for connecting to a pointing device such as a computer mouse, a port for connecting to a printer, or a port for connecting to a USB driver. The expansion card 2500 may be implemented as a secure digital (SD) card or a multimedia card (MMC). According to an embodiment, the expansion card 2500 may be a subscriber identification module (SIM) card or a universal subscriber identity module (USIM). The network device 2600 may be a device that may connect the computing system 2000 to a wired network or a wireless network. The display 2700 may display data output from the memory device 2300, the I/O ports 2400, the expansion card 2500, or the network device 1600.

The camera module 2800 is a module that may convert an optical image into an electrical image. Accordingly, an electrical image output from the camera module 2800 may be stored in the memory device 2300 or the expansion card 2500. In addition, an electrical image output from the camera module 2800 may be displayed via the display 2700 according to the control of the multi-CPU system 2100.

While the concepts described herein have been particularly shown and described with reference to exemplary embodiments thereof, it will be understood that various changes in form and details may be made therein without departing from the spirit and scope of the following claims.

What is claimed is:

1. A central processing unit (CPU) system, comprising:
a CPU configured to execute a program based on a plurality of pieces of register information;
a CPU hang-up detector configured to detect a hang-up state of the CPU and generate a CPU hang-up occurrence signal; and
a memory that stores debug logic configured to gather the plurality of pieces of register information from the CPU in response to the CPU hang-up occurrence signal before a reset operation for the CPU is performed.

2. The CPU system of claim 1,
wherein the plurality of pieces of register information comprises first program counter register information including a memory address at which an instruction to be presently executed by the CPU has been stored.

3. The CPU system of claim 2,
wherein when the CPU is configured to execute the program by using a pipe-line method, the plurality of pieces of register information further comprises second program counter register information including a memory address at which an instruction to be presently executed by the CPU has been stored,
wherein the second program counter register information is generated on the basis of the first program counter register information and offset information.

4. The CPU system of claim 1,
wherein the plurality of pieces of register information comprises link register information including a memory address at which an instruction to be executed by the CPU in response to a branch return instruction has been stored.

5. The CPU system of claim 1,
wherein the CPU comprises a stack area for storing stack information,
wherein the plurality of pieces of register information comprises program state register information indicating an operation state of the CPU and stack pointer register information including a pointer address pointing to the stack information.

6. The CPU system of claim 1,
wherein the debug logic is configured to provide an operation completion signal to the CPU hang-up detector when an operation of gathering the plurality of pieces of register information is completed,
wherein the CPU hang-up detector is configured to control performing the reset operation for the CPU in response to the operation completion signal.

7. The CPU system of claim 6, further comprising:
a cache unit that stores cache data used when the CPU executes the program,
wherein the CPU hang-up detector is configured to control performing the reset operation for the CPU and control performing an operation of preserving the cache data stored in the cache unit.

8. The CPU system of claim 7,
wherein the CPU is configured to flush the preserved cache data to an external memory device and update data stored in the external memory device.

9. The CPU system of claim 1,
wherein the CPU system is a multi-CPU system comprising a plurality of CPUs,
wherein the CPU hang-up detector is configured to detect a hang-up state of at least one of the plurality of CPUs and generate the CPU hang-up occurrence signal,
wherein the debug logic is configured to gather a plurality of pieces of register information corresponding to each of the plurality of CPUs from the plurality of CPUs in response to the CPU hang-up occurrence signal before a reset operation for the plurality of CPUs is performed.

10. The CPU system of claim 9,
wherein the debug logic comprises a plurality of storage areas respectively storing for each of the plurality of CPUs the plurality of pieces of register information corresponding to each of the plurality of CPUs.

11. A debugging method of a computing system that includes a central processing unit (CPU) system comprising a CPU configured to execute a program based on a plurality of pieces of register information and a debugger configured to debug the CPU system, the debugging method comprising:
detecting a hang-up state of the CPU system and generating a CPU hang-up occurrence signal;
gathering the plurality of pieces of register information from the CPU in response to the CPU hang-up occurrence signal before a reset operation for the CPU system is performed; and
debugging, by the debugger, the CPU system based on the gathered plurality of pieces of register information.

12. The debugging method of claim 11, further comprising:
controlling the reset operation of the CPU system after completing the gathering of the plurality of pieces of register information.

13. The debugging method of claim 12,
wherein the CPU system further comprises a cache unit configured to store cache data used when the CPU executes the program, and
wherein performing the reset operation comprises controlling an operation of preserving the cache data stored in the cache unit.

14. The debugging method of claim 13,
wherein the computing system further comprises a memory device configured to store data used when the CPU executes the program, and
wherein the debugging method further comprises flushing the preserved cache data to the memory device and updating data stored in the memory device.

15. The debugging method of claim 14,
wherein the debugging, by the debugger, of the CPU system comprises debugging the CPU system based on updated data stored in the memory device and the gathered plurality of pieces of register information.

16. A central processing unit (CPU) system, comprising:
a memory that stores debug logic configured to gather a plurality of pieces of register information from a CPU in response to a CPU hang-up occurrence signal before a reset operation for the CPU is performed; and
a CPU configured to execute a program based on the plurality of pieces of register information,
wherein the central processing unit system is configured to detect a hang-up state of the CPU and generate the CPU hang-up occurrence signal so that the debug logic gathers the plurality of pieces of register information from the CPU in response to the CPU hang-up occurrence signal before a reset operation for the CPU is performed.

17. The central processing unit system of claim 16,
wherein the plurality of pieces of register information comprise a memory address at which an instruction to be presently executed by the CPU has been stored.

18. The central processing unit system of claim 16,
wherein the CPU comprises a stack area for storing stack information,
wherein the plurality of pieces of register information comprises program state register information indicating an operation state of the CPU and stack pointer register information including a pointer address pointing to the stack information.

19. The central processing unit system of claim 16, further comprising:
a cache unit which stores cache data used when the CPU executes the program,
wherein central processing unit system is configured to perform the reset operation for the central processing unit while preserving the cache data stored in the cache unit.

20. The central processing unit system of claim 19,
wherein the central processing unit system is configured to flush the preserved cache data to an external memory device and update data stored in the external memory device.
